(19) United States
(12) Patent Application Publication
(10) Pub. No.: US 2008/0224534 A1
(43) Pub. Date: Sep. 18, 2008

(54) Solenoid Valve Device for Vehicle Brake Systems

(76) Inventors: Guenther Schnalzger, Blaichach (DE); Martin Kirschner, Blaichach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/995,754

(22) PCT Filed: May 31, 2006
(86) PCT No.: PCT/EP2006/062792

§ 371 Date: Jan. 15, 2008

(30) Foreign Application Priority Data
Jul. 15, 2005 (DE) 102005033134.3

(51) Int. Cl. B60T 8/36; F16K 31/06

(52) U.S. Cl. 303/119.3

(57) ABSTRACT

The invention relates to a solenoid valve arrangement for an automotive braking system which arrangement is configured as a three-position/three-way valve. The invention is improved over the prior art in that two armatures and a single armature winding are assembled together such that both armatures can be displaced by the single armature winding. Each of the two armatures is associated with a respective sealing seat and the two sealing seats are situated on one side of the solenoid valve device, viewed in the axial direction of the armatures. The two sealing seats are embodied in a particularly advantageous fashion in or on a common sealing washer. The two sealing seats are arranged in a single sealing washer in such a way that the latter can be preassembled and then inserted into a predetermined location in the final assembly of the vehicle brake system solenoid valve device.

### PRIOR ART

The invention relates to a solenoid valve device for vehicle brake systems of the kind used, for example, in antilock brake systems, traction control systems, or vehicle dynamics control systems of motor vehicles. In vehicle brake systems of this kind, it is known to use three-position three-way valves (so-called 3/3-way valves) since they require a particularly small amount of space in comparison to two-position two-way valves and permit a reduction in the total number of solenoid valve devices required in the vehicle brake system.

Known 3/3-way valves that particularly fulfill the boundary conditions present in vehicle brake systems, however take up a comparatively large amount of space and are of such a complex design that the cost goals sought with them cannot be achieved in the manufacturing process. Moreover, the further development of solenoid valve devices in vehicle brake systems requires an additional reduction in weight.

### OBJECT AND EMBODIMENT OF THE INVENTION

The object of the present invention is to improve a vehicle brake system solenoid valve device of the type mentioned at the beginning so that the cost goals sought are achieved and in addition, a further reduction in weight and in the amount of space required is achieved in comparison to known three-position three-way valves of vehicle brake systems.

The object is attained according to the invention with a vehicle brake system solenoid valve device, which is embodied in the form of a three-position three-way valve and in which two armatures and a single armature winding are provided and both of the armatures can be moved with the one armature winding.

By contrast with known 3/3-way valves of vehicle brake systems, according to the invention, a solenoid valve device is provided, which is embodied with two “floating” armatures. The two armatures can be actuated with a single armature winding, thus making it possible to keep the structural design of the solenoid valve device particularly simple. In addition, this construction according to the invention results in particular advantages with regard to space, weight, and the connection situation of hydraulic lines that are provided in the vehicle brake system solenoid valve device according to the invention.

In an advantageous modification of the vehicle brake system solenoid valve device according to the invention, each of the two armatures is associated with a respective sealing seat and the two sealing seats are situated on one side of the solenoid valve device, viewed in the axial direction of the armatures. An embodiment of this kind and an arrangement of sealing seats in the vehicle brake system solenoid valve device according to the invention results in the fact that an inlet valve seat and outlet valve seat can be situated on one side of the solenoid valve device, thus allowing these sealing seats to also be installed from one side into a pump housing block. A two-sided installation of sealing seats, as is sometimes required in antilock brake systems, or a particular return routing of lines inside a pump housing block, as is also described in the prior art, can by contrast be eliminated according to the present invention.

In the embodiment according to the invention, known production techniques such as drawing, drop-forging, stamping, and other large-series techniques can be used to inexpensively manufacture and assemble the required parts of the vehicle brake system solenoid valve device.

The two above-mentioned sealing seats of the vehicle brake system solenoid valve device according to the invention are embodied in a particularly advantageous fashion in or on a common sealing washer. The expression “embodied . . . in or on a common sealing washer” used here is understood to mean that the individual sealing seat is formed into the sealing washer itself or is formed into a separate component that is then inserted into the sealing washer. The important thing is that it the two sealing seats are arranged in a single sealing washer in such a way that the latter can be preassembled and then inserted into a predetermined location in the final assembly of the vehicle brake system solenoid valve device according to the invention. It is then possible, before the sealing washer is installed, for it to already be specially tested with regard to the sealing seats embodied in it.

In addition, such a sealing washer is also particularly well-suited to constitute an additional sealing view situated on it. In a particularly advantageous way, this additional sealing seat is associated with a check valve, thus making it possible to further increase the functionality of the solenoid valve device.

In order to achieve a particularly compact design, it is advantageous to situate the three sealing seats in a triangular arrangement on the sealing washer, viewed in cross section. Alternatively, the sealing seats can also be arranged along a straight line, but as a rule, this requires a larger amount of space.

It is also advantageous that a master brake cylinder exerts brake pressure on one of the end surfaces of the above-mentioned sealing washer on which the three above-mentioned sealing seats are advantageously embodied. Depending on the switching position of the associated valves, the brake pressure can be advantageously conveyed through one of the two sealing seats and/or through the check valve.

In order to be able to achieve the switching positions of the two armatures required for vehicle brake system in a particularly simple fashion with only one armature winding, it is advantageous if the two armatures each have an armature core and these two armature cores are then arranged in axial series with each other.

In addition, the two armatures should be able to selectively seal the associated sealing seats with the aid of valve tappets. In order to prevent the device from jamming during this movement of the valve tappets, it is particularly advantageous if one of the two armatures has a tappet that is guided so that it extends through the armature core of the other armature. The necessary cushioning of the individual tappets should be embodied coaxial and concentric to each individual tappet. This prevents the spring force from skewing the armatures and tappets. In addition, the pole faces of the armatures should have surface areas that are as symmetrical and balanced as possible, which can be advantageously achieved in that each of the two armatures has a tappet and the two tappets are arranged next to each other, viewed in cross section. This modification likewise prevents a skewing of the armatures and tappets, this time due to transverse magnetic forces.

In order to achieve a compact embodiment as well as balanced spring and magnetic forces, it is also particularly advantageous if the two tappets, viewed in cross section, are essentially arranged diametrically opposite each other within a circular form.

For the achievement of the desired switching positions, it is also advantageous if the above-mentioned armatures are supported by means of return springs of different strengths.

### BRIEF DESCRIPTION OF THE DRAWINGS

Exemplary embodiments of vehicle brake system solenoid valve devices according to the invention will be explained in greater detail below in conjunction with the accompanying schematic drawings.

FIG. 1 shows a longitudinal section through a first exemplary embodiment of a vehicle brake system solenoid valve device according to the invention,

FIG. 2 shows the section II-II according to FIG. 1,

FIG. 3 shows the section according to FIG. 2 in a second exemplary embodiment of a vehicle brake system solenoid valve device according to the invention, and

FIG. 4 shows the section according to FIG. 2 in a third exemplary embodiment of a vehicle brake system solenoid valve device according to the invention.

### DETAILED DESCRIPTION OF THE EXEMPLAR EMBODIMENTS

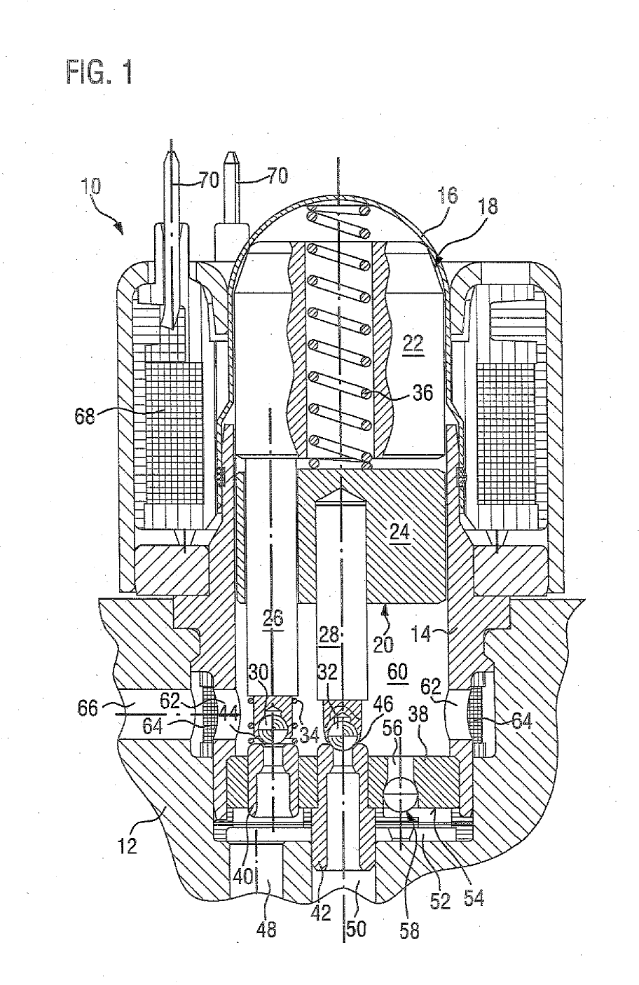

FIG. 1 shows a longitudinal section through a vehicle brake system solenoid valve device 10, which is embodied according to the invention in the form of a three-position three-way valve.

The solenoid valve device 10 is situated in a cubical hydraulic block 12 made of aluminum, which is only partly shown, and, as central components, includes a tubular guide sleeve 14, which is inserted into the hydraulic block 12 and has a hat-shaped guide cap 16 slid onto it. A first armature 18 and a second armature 20 are contained and each guided in floating fashion inside the thusly arranged guide sleeve 14 and guide cap 16.

The two armatures 18 and 20 are situated in axial series and, in FIG. 1, are situated one above the other. They each include an essentially cylindrical armature core 22, 24 and a tappet 26, 28 protruding downward from the armature core. The tappet 26 of the upper armature 18 extends axially through the armature core 24 of the lower armature 20. The tappet 28 of the lower armature 20 extends far into its armature core 24.

A sealing ball 30, 32 is affixed in stationary fashion to the lower end region of each of the tappets 26 and 28.

The lower armature 20 is supported against the hat-shaped guide cap 16 by means of a return spring 34 that extends through the armature core 22 of the upper armature 18 and exerts a spring force on the armature core 24 of the armature 20 in its center, viewed in cross section, on the side opposite from the tappet 28. A return spring 36, which is situated in the lower end region of the tappet 26 and rests against a sealing washer 38, resiliently prestresses the armature 18 upward in FIG. 1. This return spring 36 resiliently prestresses the tappet 26 in a centered fashion (similar to the prestressing of the tappet 28).

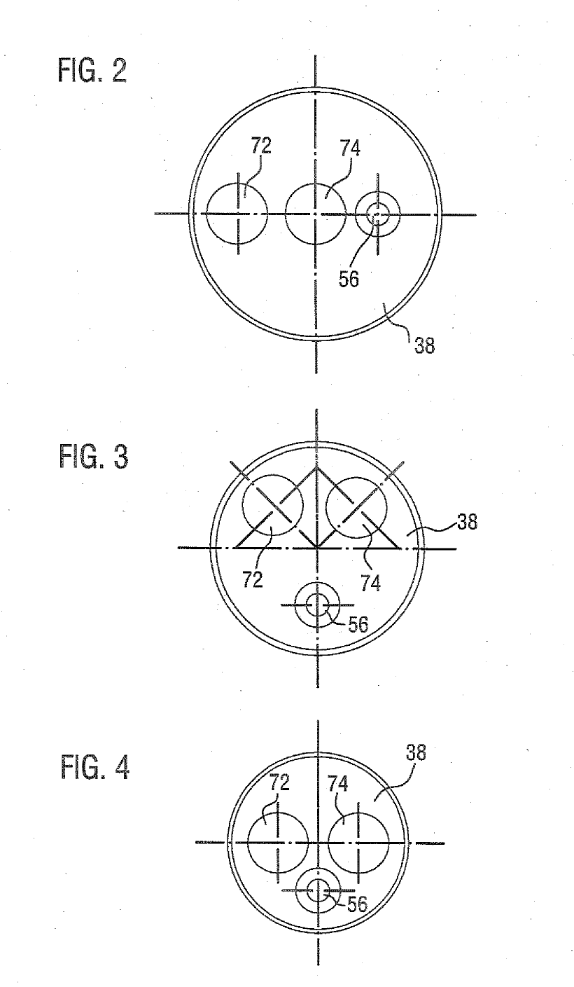

A first hollow, cylindrical feedthrough 40 situated on the left in FIG. 1 and a second hollow, cylindrical feedthrough 42 situated on the right in FIG. 1 are inserted into the sealing washer 38 (as is also clear in FIGS. 2 through 4). At their upper ends in FIG. 1, these feedthroughs 40 and 42 each have a sealing seat, 44 and 46 respectively, which are situated opposite the sealing balls 30 and 32 mentioned above.

A supply line 48 and a return line 50 are routed to the lower end region in FIG. 1 of the feedthroughs 40 and 42. The supply line 48 supplies pressurized hydraulic fluid from a master brake cylinder (not shown) of the associated vehicle brake system to the feedthrough 40 and also to a transverse conduit 52 that is situated at the bottom end surface 54 of the sealing washer 38 in FIG. 1. This transverse conduit 52 also conveys the hydraulic fluid to a through opening 56, which (like the feedthroughs 40 and 42) also passes through the sealing washer 38. The through opening 56 contains a check valve 58 that is able to selectively close the through opening 56.

On the upper side of the sealing washer 38 in FIG. 1, a plurality of openings 62 distributed around the circumference of the guide sleeve 14 lead outward from an inner chamber 60 formed by the guide sleeve 14. These openings 62 are encompassed by a filter ring 64 and are connected to a wheel connection line 66 that leads to wheel brake cylinders (not shown).

An essentially hollow, cylindrical armature winding 68, which is provided with two electrical connections 70 for connection to a control unit (not shown), encompasses the outside of the upper section of the tubular guide sleeve 14 in FIG. 1 and the hat-shaped guide cap 16.

The vehicle brake system solenoid valve device 10 thus embodied functions as follows:

In the state shown in FIG. 1, the sealing seat 44 is open and a driver of the associated motor vehicle is able to build up pressure from the master brake cylinder to the wheel brake cylinder. In the event of an excessive braking pressure and a locking of the associated wheel, a first current stage in the armature winding 68 moves the upper armature 18 toward the lower armature 20. The return spring 34 is embodied so that it has a higher spring force than the return spring 36. This higher spring force thus prevents the armature 20 from moving upward in FIG. 1. The result is a closing of only the sealing seat 44 with the aid of the sealing ball 30 situated at the end of the tappet 26. This locks the pressure in the wheel brake cylinder, thus resulting in a pressure maintenance stage.

If the wheel remains locked, a second current stage moves the lower armature 20 toward the upper armature 18 in the upward direction in FIG. 1. In this case, the tappet 26 against the sealing seat 44 prevents the upper armature 18 from being able to continue moving in its advancing direction (i.e. toward the bottom in FIG. 1).

The movement of the lower armature 20 in the upward direction in FIG. 1 causes the associated tappet 28 and the sealing ball 32 situated on it to lift away from the sealing seat 46, thus opening the passage into the return line 50 to a return feed pump (not shown).

This opening of the return line 50 reduces the pressure at the wheels whose locking is thus released.

If the driver stops actuating the brakes, then the armature winding 68 reverts to the currentless initial state as a result of which the return springs 34 and 36 push the armatures 18 and 20 back into the initial position depicted in FIG. 1. Then the springless check valve 58 can open in order to open up an additional return cross section and prevent a continued braking due to an excessively slow pressure decrease from the wheel brake cylinder through the sealing seat 44. The check valve 58 closes in an automatic (and pressure-assisted) fashion as soon as a pressure increase occurs again due to a brake actuation triggered by the driver or by another control system.

FIGS. 2 through 4 show several embodiments for possible arrangements of the two sealing seats 44 and 46 and of the check valve 58 within the cross sectional area of the sealing washer 38. The embodiment shown in FIG. 2 has a linear arrangement of these three elements. Such an arrangement can make particular sense from a production standpoint, but requires a comparatively large cross sectional area for the sealing washer 38. This large cross sectional area is in particular required by the fact that in the present instance, in order to embody the sealing seats 44 and 46, the above-mentioned feedthroughs 40 and 42 in the form of hollow, cylindrical sleeves are provided in the sealing washer 38. Providing such sleeves can also make particular sense for production engineering reasons because this allows special materials and surfaces to be used for the above-mentioned sealing seats 44 and 46. Two bores 72 and 74 are thus provided in the sealing washer 38 for the feedthroughs 40 and 42. In an alternative embodiment that is not shown and is also very advantageous, however, the feedthroughs 40 and 42 are omitted and the sealing seats 44 and 46 are embodied directly in the sealing washer 38. In an embodiment form of this kind, it is also optionally possible for the cross sectional area of the sealing washer 38 to be embodied as smaller.

Other very advantageous embodiments for reducing the cross sectional area of the sealing washer 38 and therefore also the overall size of the solenoid valve device 10 are the embodiments shown in FIGS. 3 and 4 in which the three elements the bore 72, the bore 74, and the through opening 56 are situated in a triangular arrangement.

FIG. 4 shows a particularly compact structural embodiment that is also easy to manufacture and in particular, yields symmetrical force ratios in the armatures 18 and 20. In this embodiment, the bores 72 and 74 are situated diametrically opposite each other, while the through opening 56 is situated in the middle of one of the cross sectional halves thus produced. Such an arrangement results in a further diameter reduction and the advantage of a particularly slight or nonexistent skewing of the armatures 18 and 20 and their tappets 26 and 28 by the transverse spring forces or magnetic forces during operation of the solenoid valve device 10.

It is also particularly advantageous if the lower armature 20 has two through openings, one of which is provided with a slight guidance play for the passage of the tappet 26 while the second through opening advantageously accommodates the tappet 28, particularly preferably by means of a press fit. The pole faces of such a lower armature 20 therefore have a balanced surface area, yielding balanced magnetic forces in relation to the upper armature 18.

### REFERENCE NUMERAL LIST

10 vehicle brake system solenoid valve device
12 hydraulic block
14 guide sleeve
16 guide cap
18 armature
20 armature
22 armature core
24 armature core
26 tappet
28 tappet
30 sealing ball
32 sealing ball
34 return spring
36 return spring
38 sealing washer
40 feedthrough
42 feedthrough
44 sealing seat
46 sealing seat
48 supply line
50 return line
52 transverse conduit
54 end surface
56 though opening
58 check valve
60 inner chamber
62 opening
64 filter ring
66 wheel connection line
68 armature winding
70 electrical connection
72 bore
74 bore

1-11. (canceled)

12. A vehicle brake system solenoid valve device embodied in the form of a three-position three-way valve, comprising:
a first armature;
a second armature; and
a single armature winding assembled together with said first armature and said second armature such that it is possible to move both armatures by means of the single armature winding.

13. The vehicle brake system solenoid valve device according to claim 12, further comprising a first sealing seat and a second sealing seat associated with said first armature and said second armature respectively, wherein both of the sealing seats are situated on one side of the solenoid valve device, as viewed in an axial direction of the armatures.

14. The vehicle brake system solenoid valve device according to claim 13, wherein the sealing seats are disposed within a common sealing washer.

15. The vehicle brake system solenoid valve device according to claim 13, further comprising a check valve associated with a third sealing seat which is disposed within a common sealing washer in addition to the first and second sealing seats.

16. The vehicle brake system solenoid valve device according to claim 14, further comprising a check valve associated with a third sealing seat which is disposed within the sealing washer in addition to the first and second sealing seats.

17. The vehicle brake system solenoid valve device according to claim 15, wherein the first, second, and third sealing seats together form a triangular arrangement within the sealing washer viewed in cross section.

18. The vehicle brake system solenoid valve device according to claim 15, further comprising a master brake cylinder disposed so as to exert brake pressure on end surfaces of the sealing washer.

19. The vehicle brake system solenoid valve device according to claim 12, wherein the first and second armatures each have an associated armature core and the armature cores are arranged in axial series with each other.

20. The vehicle brake system solenoid valve device according to claim 13, wherein the first and second armatures each have an associated armature core and the armature cores are arranged in axial series with each other.

21. The vehicle brake system solenoid valve device according to claim 14, wherein the first and second armatures each have an associated armature core and the armature cores are arranged in axial series with each other.

22. The vehicle brake system solenoid valve device according to claim 15, wherein the first and second armatures each have an associated armature core and the armature cores are arranged in axial series with each other.

23. The vehicle brake system solenoid valve device according to claim 16, wherein the first and second armatures each have an associated armature core and the armature cores are arranged in axial series with each other.

24. The vehicle brake system solenoid valve device according to claim 19, wherein the first armature has a tappet that is guided so that it extends through the armature core associated with the second armature.

25. The vehicle brake system solenoid valve device according to claim 12, wherein the first and second armatures each has an associated tappet and the tappets are arranged next to each other, viewed in cross section.

26. The vehicle brake system solenoid valve device according to claim 13, wherein the first and second armatures each has an associated tappet and the tappets are arranged next to each other, viewed in cross section.

27. The vehicle brake system solenoid valve device according to claim 14, wherein the first and second armatures each has an associated tappet and the tappets are arranged next to each other, viewed in cross section.

28. The vehicle brake system solenoid valve device according to claim 25, wherein the tappets, viewed in cross section, are essentially arranged diametrically opposite each other within a circular form.

29. The vehicle brake system solenoid valve device according to claim 12, wherein the first and second armatures each have an associated armature core that are each resiliently prestressed by a respective return spring and the two return springs are embodied with different spring forces.

30. The vehicle brake system solenoid valve device according to claim 13, wherein the first and second armatures each have an associated armature core that are each resiliently prestressed by a respective return spring and the two return springs are embodied with different spring forces.

31. The vehicle brake system solenoid valve device according to claim 14, wherein the first and second armatures each have an associated armature core that are each resiliently prestressed by a respective return spring and the two return springs are embodied with different spring forces.
